(19) United States
(12) Patent Application Publication
(10) Pub. No.: US 2005/0000143 A1
(43) Pub. Date: Jan. 6, 2005

(54) Wildlife attractant using artificial food

(76) Inventors: James G. Smith, Aberdeen, MS (US); Brian K. Morgan, Aberdeen, MS (US)

Correspondence Address: James G. Smith, 312 Big John Road, Aberdeen, MS, 39730, US

(21) Appl. No.: 10/752,594

(22) Filed: Aug. 2, 2004

Related U.S. Application Data
(60) Provisional application No. 60/439,408, filed on Jan. 9, 2003.

(51) Int. Cl. A01M 31/06

(52) U.S. Cl. 43/2

(57) ABSTRACT

This invention is designed to attract wildlife by simulating a real food product that attracts them. Currently, there are other methods of attracting wildlife, but this invention allows the user to attract wildlife without using real food, as it is illegal in some states to use real food as a wildlife attractant. Some users may find it beneficial because unlike real food, it will not decompose, and cannot be ingested; therefore it could last indefinitely and be used over and over again. This would make this a cost effective means of attracting wildlife.

### BACKGROUND OF THE INVENTION

1. Field of the Invention

This invention relates to attracting wildlife using artificial food or other similar luring devices, and especially artificial food that is piled upon a surface.

2. Discussion of the Prior Art

Wildlife has traditionally been attracted by using sound, scent, or decoy attractants. These inventions although adequate lack the attractive nature of food. Accordingly, there is a need for a device and method that uses artificial food to attract wildlife.

### SUMMARY OF THE INVENTION

This invention provides a device for attracting wildlife by using artificial food or other similar luring devices. Wildlife is attracted to the sight of food and the use of artificial food that is piled, collected, and/or scattered upon a surface has been shown to attract wildlife. This device can be used by hunters, wildlife observers, or other individuals or groups who need to or desire to attract wildlife to a location. The artificial food is designed so that is lightweight and maintainable.

### DETAILED DESCRIPTION

This invention provides for a portable luring device for hunters and wildlife observers to attract wildlife such as deer to an area. The luring device is constructed of plastic, ceramic, or other non-edible materials and is made to resemble a pile, collection and/or scattering of food that naturally attracts wildlife. Additionally or alternatively, the device can be painted or colored to resemble food.

One example is a molded pile which has the appearance of shelled corn comprising molded plaster painted to resemble a pile of shelled corn. In experiments, it was shown that deer were attracted to this embodiment of this invention.

### PREFERRED EMBODIMENT

In one preferred embodiment of this invention, the luring device is constructed of plastic, ceramic, or other non-edible materials and is made to resemble a pile, collection and/or scattering of food that attracts wildlife.

In another preferred embodiment; of this invention, the luring device is painted or colored to resemble food.

In another preferred embodiment of this invention, the wildlife attractant device comprises: a pile, collection, and/or scattering of material which appears edible to wildlife or otherwise attracts wildlife due to color or shape.

In another preferred embodiment of this invention, the wildlife attractant device comprises: a pile, collection, and/or scattering of artificial food which appears edible to wildlife or otherwise attracts wildlife due to color or shape.

In another preferred embodiment of this invention, the artificial food is made to represent apples, rice, poke salad, silage, peanuts, grain, honeysuckle, lespedeza, peas, corn, shelled corn, wheat, millet, sunflower seeds, soybeans, sorghum, grass, turnip, oats, vetch, rape, cabbage, beets, broccoli, cantaloupe, carrots, cauliflower, collars, cucumber, eggplant, gourds, kale, lettuce, mustard, okra, parsley, parsnip, peppers, pumpkin, radish, rutabaga, spinach, squash, swiss chard, tomato, turnip, watermelon, or combinations thereof.

In another preferred embodiment of this invention, the artificial food is made of plastic, ceramic, any material that is non-edible to wildlife, or combinations thereof.

In another preferred embodiment of this invention, the wildlife that is attracted is deer, bobwhite quail, rabbit, squirrel, raccoon, opossum, bobcat, frogs, turkey, teal, Canada goose, woodcock, snipe, moorhens, gallinules, rails, clapper, king, mourning dove, crow, ducks, mergansers, coots, pintails, canvasbacks, brant, white-fronted goose, snow goose, blue goose, ross goose, antelope, alligator, javelina, chicken, pheasant, quail, hares, bear, moose, ram, caribou, muskoxen, beaver, coyote, hogs, fox, lynx, grouse, any other wildlife that is desired or needed to be attracted. or combinations thereof.

1. We claim that this invention provides a device for attracting wildlife by using artificial food or other similar luring devices. We further claim this invention provides for a portable luring device for hunters and wildlife observers to attract wildlife such as, but not limited to, deer, to an area. The luring device is constructed of plastic, ceramic, or other non-edible materials and is made to resemble a pile, collection and/or scattering of food that naturally attracts wildlife. Additionally or alternatively, the device can be painted or colored to resemble food.
